(19) United States
(12) Patent Application Publication
(10) Pub. No.: US 2007/0142697 A1
(43) Pub. Date: Jun. 21, 2007

(54) Apparatus for connection of implantable devices to the auditory system

(76) Inventor: Robert Edwin Schneider, Erie, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/351,682

(22) Filed: Dec. 16, 2005

(51) Int. Cl. H04R 25/00

(52) U.S. Cl. 600/25

(57) ABSTRACT

A connection apparatus for coupling an implantable device, such as a hearing aid transducer, to a middle ear component. The connection apparatus includes a first joint member on the implantable device and a second joint member connectable to the middle ear component. The first and second joint members are themselves connectable during implantation of the device to couple the device and the middle ear component. In one embodiment of the invention, the first and second joint members may form a detachable connection to facilitate removal for repair and or replacement of the device

### FIELD OF THE INVENTION

The invention is related to the field of hearing aids, and in particular, to connections between implantable hearing aid transducers a component of the auditory system.

### BACKGROUND OF THE INVENTION

Implantable hearing aids entail the subcutaneous positioning of some or all of various hearing augmentation componentry on or within a patient's skull, typically at locations proximate the mastoid process. Implantable hearing aids may be generally divided into two classes, semi-implantable and fully implantable. In a semi-implantable hearing aid, components such as a microphone, signal processor, and transmitter may be externally located to receive, process, and inductively transmit a processed audio signal to implanted components such as a receiver and transducer. In a fully-implantable hearing aid, typically all of the components, e.g., the microphone, signal processor, and transducer, are located subcutaneously. In either arrangement, a processed audio signal is provided to a transducer to stimulate a component of the auditory system

By way of example, one type of implantable transducer includes an electromechanical transducer having a magnetic coil that drives a vibratory actuator. The actuator is positioned to mechanically stimulate the ossicles via physical engagement. (See e.g., U.S. Pat. No. 5,702,342). In this regard, one or more bones of the ossicles are made to mechanically vibrate, causing the vibration to stimulate the cochlea through its natural input, the so-called oval window. An example of this transducer is included in the MET™ hearing aid of Otologics, LLC, in which a small electromechanical transducer is used to vibrate the incus (the 2nd of the 3 bones forming the ossicles), and thence produce the perception of sound. In this case, the vibratory actuator is coupled to the ossicles during mounting and positioning of the transducer within the patient. In one example, such coupling may occur via a small aperture formed in the incus bone.

As will be appreciated, coupling with the ossicles poses numerous challenges. For instance, during positioning of the transducer, it is often difficult for an audiologist or surgeon to determine the extent of the coupling. In other words, how well the actuator is attached to the ossicles. Additionally, due to the size of the transducer relative to the ossicles, it is difficult to determine if loading exists between the ossicles and transducer. In this regard, precise control of the engagement between the actuator of the transducer and the ossicles is of critical importance as the axial vibrations can only be effectively communicated when an appropriate interface or load condition exists between the transducer and the ossicles. Overloading or biasing of the actuator can result in damage or degraded performance of the biological aspect (movement of the ossicles) as well as degraded performance of the mechanical aspect (movement of the vibratory member). Additionally, an underloaded transducer, e.g., where the actuator is not fully connected to the ossicles, may result in reduced performance of the transducer.

Another difficulty with such coupling is that in some cases patients can experience a “drop-off” in hearing function after implantation. Such a drop off -may be caused by changes in the physical engagement of the actuator, e.g., due to things such as tissue growth, or may be caused by a malfunction of the transducer or other componentry. After implantation, however, it is difficult to readily assess the performance and/or adjust an implanted transducer and interconnected componentry. For example, in the event of a “drop-off” in hearing function after implantation, it is difficult to determine the cause, e.g., over/under loading of the interface due to tissue growth or some other problem with the hearing aid, without invasive and potentially unnecessary surgery. In addition, once coupled for an extended period, the maintenance and/or replacement with a next generation transducer may be difficult.

### SUMMARY OF THE INVENTION

In view of the foregoing, a primary object of the present invention is to simplify and improve implantation procedures for implantable devices, such as hearing aid transducers. Another object of the present invention is to provide a means for achieving a low mechanical bias or no-load interface between transducers and a component of the auditory system, e.g., the ossicles. A related object of the present invention is to provide a connection apparatus with the ability to compensate in situ for undesirable interfaces, should one exist, between the middle ear component and a transducer, e.g., loading therebetween. Another object of the present invention is to provide a known geometry or uniform interface, on a middle ear component for making a connection with a transducer. In the context of the present invention, “in situ,” refers to in its proper position, e.g., in the context of the present transducer, as implanted in a patient and coupled to a middle ear component.

One or more of the above objectives and additional advantages may be realized by a first aspect of the present invention, which provides a connection apparatus for coupling an implantable device, e.g., a hearing aid transducer, to a middle ear component. The connection apparatus includes a first joint member on the transducer, e.g., interconnected to a vibratory member of the transducer, and a second joint member connectable to the middle ear component, e.g., the ossicles. The connection apparatus further includes a means for coupling the first and second joint members during implantation of the transducer to provide a communication path between the coupled joint members for the transmission of mechanical energy from the transducer to the ossicles. In the context of the subject first aspect, the coupling of the first and second joint members may include an actual connection made therebetween or may include adjacent positioning of the joint members relative to each other to define the communication path.

Various refinements exist of the features noted in relation to the subject first aspect of the present invention. Further features may also be incorporated in the subject first aspect of the present invention as well. These refinements and additional features may exist individually or in any combination. For instance according to a first feature, the second joint member may be configured to connect to the ossicles of the patient, in a substantially permanent manner. The permanent connection may be achieved through an artificial means such as an adhesive, or through bone growth or a fibrous tissue union naturally formed as a function of the body's response to the implantation. In some cases, an adhesive or other means may also be utilized to initially secure the joint member to the ossicles until such time as a natural connection via bone or tissue growth forms.

According to another feature of the subject aspect, the first and second joint members may form a detachable connection. The detachable connection between the joint members, in combination with the permanent connection of the second joint member to the ossicles, provides a known geometry for connection and disconnection of a transducer, as well as reconnection of the transducer, such as for repair or replacement. In this regard, the second joint member is preferably of a minimal size that provides for a connection with the first joint member. This permits the second joint member to remain attached to the ossicles, even following a permanent removal of the transducer and first joint member, without affecting the auditory function. In other words, since the Second joint member is relatively small in comparison to a transducer, it is anticipated that the joint member may remain connected to the ossicles, even after permanent removal of the transducer, without substantial affects to the mechanical function of the auditory system.

The connection between the joint members can be made in any manner as a matter of design choice to define the communication path for transmission of mechanical energy to the ossicles. For instance, in one aspect of the connection apparatus, one of the joint members may be a stud including a ball disposed on one end, while the other one of the joint members may be a receiver/pocket that forms a ball joint connection with the stud member. Advantageously, such a connection minimizes loading between the ossicles and the transducer by permitting rotational movement between the joint members. The ball joint connection may also be further engineered to permit additional compensational movements between the joint members to minimize loading. For instance, the receiver/pocket may be connected to the transducer or the ossicles via a stem member. The stem member, in turn, may be formed from a flexible material that permits non-permanent deformation in response to compressive forces between the transducer and ossicles. In another example according to this characterization, the stem and receiver/pocket may be defined by a pair of flexible structures that displace in a non-permanent manner in response to compressive forces between the transducer and ossicles.

In another aspect of the connection apparatus, one of the joint members may be a stud member having a planer end for adjacent positioning relative to the other one of the joint members, which also includes a planer end. According to this characterization, the joint members are adjacently positionable during implantation to define the communication path.

In another aspect of the connection apparatus, the joint members may be a pair of studs that are connectable in a detachable manner. For instance, in one example, a mechanical connection may be formed using a shape memory alloy to provide the detachable connection.

In another aspect of the connection apparatus, the first joint member may be a stud member while the second joint member is a sleeve or conduit that is connectable to the ossicles, e.g., in an aperture/interface formed therein. According to this characterization, a tip of the stud member is insertable into the sleeve member to make the connection between the joint members. Although not necessary according to the present aspect, a material reshapeable in situ may also be disposed within the sleeve between the connected joint members to permit gradual movement of the joint members relative to each other to minimize loading. According to this characterization the reshapeable material may be a material that is resistive to high frequency movements to permit efficient acoustic stimulation of the ossicles, but gradually displaceable, e.g., in response to a steady state application of pressure by the ossicles, at body temperature to minimize loading. In this regard, the reshapeable material may also be utilized to secure the tip within the sleeve. In another example according to this aspect, an adhesive, or other means, such as a threaded connection may also be utilized to secure the tip within the sleeve as a matter of design choice.

According to a second aspect of the present invention, a method for coupling an implantable device, e.g., a hearing aid transducer, to the ossicles of a patient is provided. The method includes the steps of providing a first joint member on the transducer, coupling a second joint member to a middle ear component, and forming a connection between the first and second joint members during implantation of the transducer to couple the transducer to the middle ear component.

Various refinements exist of the features noted in relation to the subject second aspect of the present invention. Further features may also be incorporated into the subject second aspect of the present invention as well. These refinements and additional features may exist individually or in any combination. For instance according to a first feature of the subject second aspect, the connection between the joint members may be achieved in any manner as a matter of design choice that provides for acoustic stimulation of the middle ear component by the transducer. For example, the connection may be a detachable connection, a permanent connection, or an adjacent positioning as described above. According to this characterization, the method may further include the step of providing a stimulus representative of sound to the middle ear component over the connected first and second joint members.

According to another feature of the subject second aspect, the method may include the step of exposing the connected first and second joint members to movement of the middle ear component, and automatically executing a compensating movement of the first and second joint members to reduce loading pressures. The step of executing the compensating movement may further include different steps according to the type of connection provided by the first and second joint members. For example, the compensating movement may include rotation of a ball relative to a receiver/pocket as described above. In another example, the compensating movement may include flexing a stem connected to the receiver/pocket or displacement of a reshapeable material between the interconnected joint members.

In one aspect of the present method, the method may further include disconnecting the joint members and removing the transducer from the patient. The removing step may include the step of permanently removing the transducer, replacing the transducer with a new transducer, and/or repairing the transducer. According to this characterization, the method may further include the step of replacing the removed transducer with the repaired or new transducer.

Those skilled in the art will appreciate numerous other examples of the basic principles of the present invention, namely, providing a connection between a pair of joint members to attach an implantable device to the a middle ear component of a patient. Furthermore, additional aspects, advantages and applications of the present invention will be apparent to those skilled in the art upon consideration of the following.

### BRIEF DESCRIPTION OF THE DRAWINGS

FIGS. 1 and 2 illustrate implantable and external componentry respectively, of a semi-implantable hearing aid system according to the present invention;

FIG. 3 illustrates one embodiment of a connection apparatus for connecting the implanted componentry of the hearing aid system of FIG. 1 to the ossicles;

FIG. 4a illustrates another embodiment of a connection apparatus for connecting the implanted componentry of the hearing aid system of FIG. 1 to the ossicles;

FIG. 4b illustrates a flexible stem member of the connection apparatus of FIG. 4a;

FIG. 5 illustrates another embodiment of a connection apparatus for connecting the implanted componentry of the hearing aid system of FIG. 1 to the ossicles;

FIG. 6a illustrates interconnection of a pair of joint members for the connection apparatus of FIG. 4a;

FIG. 6b illustrates an example of a means for disconnecting the interconnection between the joint member of FIG. 6;

FIG. 7 illustrates another embodiment of a connection apparatus for connecting the implanted componentry of the hearing aid system of FIG. 1 to the ossicles;

FIG. 8 illustrates another embodiment of a connection apparatus for connecting the implanted componentry of the hearing aid system of FIG. 1 to the ossicles;

FIG. 9 illustrates another embodiment of a connection apparatus for connecting the implanted componentry of the hearing aid system of FIG. 1 to the ossicles;

FIG. 10 illustrates another embodiment of a connection apparatus for connecting the implanted componentry of the hearing aid system of FIG. 1 to the ossicles;

FIG. 11 illustrates another embodiment of a connection apparatus for connecting the implanted componentry of the hearing aid system of FIG. 1 to the ossicles;

FIG. 12 illustrates another embodiment of a connection apparatus for connecting the implanted componentry of the hearing aid system of FIG. 1 to the ossicles; and

FIG. 13 illustrates interconnection of a pair of joint members for the connection apparatus of FIG. 12.

### DETAILED DESCRIPTION

Reference will now be made to the accompanying drawings, which at least assist in illustrating the various pertinent features of the present invention. In this regard, the following description of a hearing aid device is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain the best modes known of practicing the invention and to enable others skilled in the art to utilize the invention in such, or other embodiments and with various modifications required by the particular application(s) or use(s) of the present invention.

Hearing Aid System:

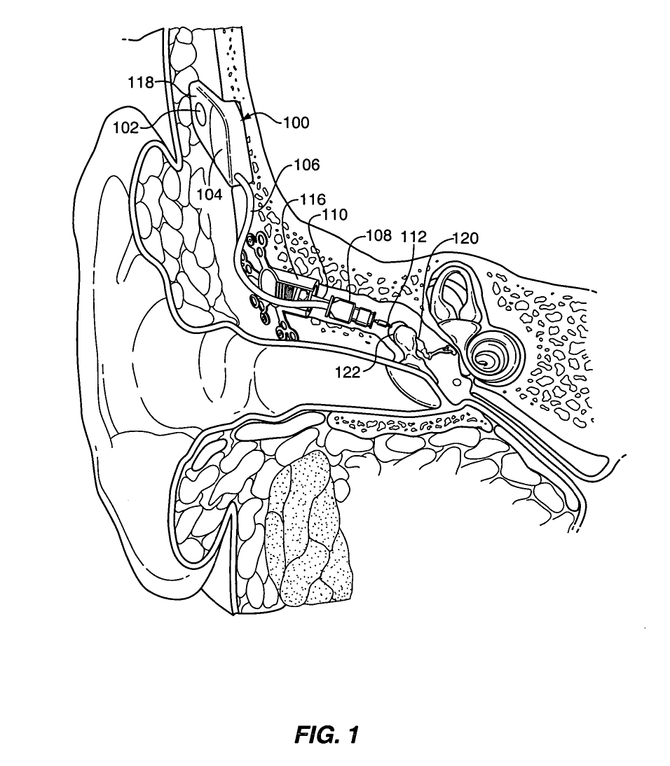

FIGS. 1 and 2 illustrate one application of the present invention. The illustrated application comprises a semi-implantable hearing aid system having implanted components shown in FIG. 1, and external components shown in FIG. 2. As will be appreciated, the present invention may be employed in conjunction with conventional hearing aids, semi-implantable hearing aids, and fully implantable hearing aids, and therefore the illustrated application is for purposes of illustration and not limitation.

In the illustrated system, an implanted biocompatible housing 100 is located subcutaneously on a patient's skull. The housing 100 includes an RF signal receiver 118 (e.g., comprising a coil element) and a signal processor 104 (e.g., comprising processing circuitry and/or a microprocessor). As will become apparent from the following description, various processing logic and/or circuitry may also be included in the housing 100 as a matter of design choice. The signal processor 104 is electrically interconnected via wire 106 to an electromechanical transducer 108. Alternatively, however, the transducer 108 may be any type of transducer connectable to a component of the auditory system such as the ossicles 120.

The transducer 108 is supportably connected to a positioning system 110, which in turn, is connected to a bone anchor 116 mounted within the patient's mastoid process (e.g., via a hole drilled through the skull). The transducer 108 includes a connection apparatus 112 for connecting the transducer 108 to the ossicles 120 of the patient. As will become apparent from the following description, the connection apparatus 112-includes first and second joint members that are connectable during implantation of the transducer 108 within the patient. In their connected state, the joint members of the connection apparatus 112 provide a communication path for acoustic stimulation of the ossicles 120, e.g., transmission of axial vibrations to the incus 122.

Referring to FIG. 2, the semi-implantable system further includes an external housing 200 comprising a microphone 208 and internally mounted speech signal processing (SSP) unit (not shown). The SSP unit is electrically interconnected to an RF signal transmitter 204 (e.g., comprising a coil element). The external housing 200 is configured for disposition behind the ear of the patient in alignment with the implanted housing 100. In this regard, the external transmitter 204 and implanted receiver 118 each include magnets, 206 and 102, respectively, to facilitate retentive juxtaposed positioning.

During normal operation, acoustic signals are received at the microphone 208 and processed by the SSP unit within external housing 200. As will be appreciated, the SSP unit may utilize digital processing to provide frequency shaping, amplification, compression, and other signal conditioning, including conditioning based on patient-specific fitting parameters. In turn, the SSP unit provides RF signals to the transmitter 204. Such RF signals may comprise carrier and processed acoustic drive signal portions. The external transmitter 204 transcutaneously transmits the RF signals to the implanted receiver 118. As noted, the external transmitter 204 and implanted receiver 118 may each comprise coils for inductive coupling of signals therebetween.

Upon receipt of the RF signals, the implanted signal processor 104 processes the signals (e.g., via envelope detection circuitry) to provide a processed drive signal via wire 202 to the transducer 108. The drive signals cause the transducer 108 to transmit axial vibrations at acoustic frequencies to the connection apparatus 112 to effect the desired sound sensation via mechanical stimulation of the incus 122 of the patient.

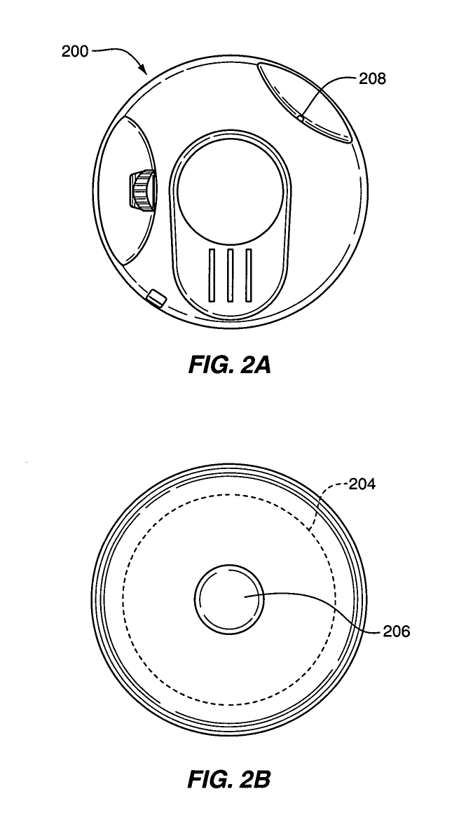

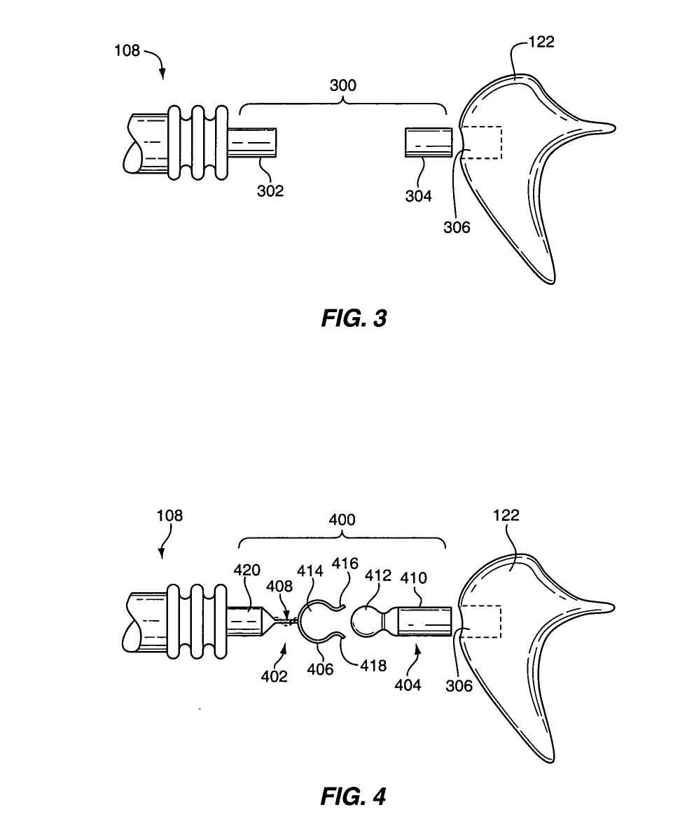

FIG. 3 illustrates a broad embodiment of the present connection apparatus 112, namely connection apparatus 300. The connection apparatus 300 is designed to provide a two-part connection between an implantable device, such as transducer 108, and the ossicles 120 of a patient. Specifically, the connection apparatus 300 includes a first joint member 302 and a second joint member 304 that are configured to form a mating connection during an implant procedure. In this regard, the joint member 302 extends from an end of the transducer 108 that is disposed towered the incus 122, and is operably interconnected to a driver of the transducer 108 such that it is axially vibratable in response to transducer drive signals. According to this characterization, the joint member 302 may be a separate structure that is connected to a vibratory member, e.g., vibratory member 112 of the transducer 108, or the vibrataroy member 112 may form the joint member 302.

The joint member 304, on the other hand, is connectable to the ossicles 120. In one example, illustrated on FIG. 3, the joint member 304 is connected to an interface 306 formed on the incus 122. According to this characterization, the interface 306 may be a shallow aperture formed in the incus 122 using an appropriate instrument, such as a laser or hand drill. Alternatively, it will be appreciated that the interface 306 may be of any nature that permits connection of the joint member 304 to the incus 122. It should be noted, that while not necessary according to the present connection apparatus 300, the joint member 304 is preferably designed for permanent attachment to the incus 122, e.g., through a mechanical couple. According to this characterization, the mechanical couple may be achieved by any appropriate method. For instance, in one example the mechanical couple may be achieved through the healing process following the implant, e.g., by bone growth or tissue growth between the joint member 304 and the interface aperture 306. Alternatively, it may be desirable to use another means such as an adhesive or surface discontinuity formed on the joint member 304 to make the connection with the incus 122. Furthermore, it may be desirable to us a combination of methods, such as the use of an adhesive during the implant procedure to temporarily secure the joint member 304 to the incus 122, until such time as the bone growth or tissue growth may form therebetween.

As will be appreciated by the examples set forth below, the connection between the joint members, 302 and 304, may be made by numerous methods now known and later invented. In this regard, however, it is preferable, but not necessary, that the connection between the joint members, 302 and 304, be detachable to achieve the specific advantage of removability of the transducer 108. Further, in this regard, the two-part connection provides a number of other advantages related to the implantation of medical devices in patients. For instance, in the present example of the hearing aid transducer 108, the joint member 304 may be utilized as uniform or standard interface on middle ear implants. This provides the advantage of accommodating connection of multiple types of transducers to the incus 122. This also facilitates removal and repair of transducers as well as replacement of transducers with next generation transducers. It is also anticipated that the two-part configuration of the present connection apparatus will facilitate the initial implantation of the transducer 108 by allowing a surgeon to couple the joint member 304 to the incus 122, prior to mounting the transducer 108 within the skull. It is anticipated that the two-part connection will make it easer to properly position and affix a transducer, such as transducer 108 to the incus 122 following connection of the joint member 304.

Furthermore, a detachable connection between the joint members, 302 and 304, provides the advantage of removability of the transducer 108, while reducing the potential for damage to the ossicles 120. In this regard, in the event it becomes desirable to permanently remove the transducer 108 from the patient, the joint member 304 may be left permanently attached to the incus 122 without substantially affecting the hearing function. In other words, because of its small size, which is on the order of approximately one (1) millimeter, the joint member 304 may be left connected to the incus 122 without affecting operation of the natural mechanical movements of the auditory system. Those skilled in the art will appreciate the numerous advantages this provides in relation to implantable devices. For instance, the transducer 108 may be removed for repair and or updating with the next generation of transducer technology. Further, the transducer 108 may be permanently removed from the patient with reduced risk of damage to the auditory system in the event that future technological advancements make the transducer 108 obsolete.

According to the above principles, the joint members, 302 and 304, may be any two members that are connectable or positionable relative to each other in a manner that provides for acoustic stimulation of the ossicles 120, with one example being the transmission of axial vibrations representative of sound between the transducer 108 and the incus 122. For instance, as will become apparent from the following description, numerous examples of the joint members, 302 and 304, may be utilized as a matter of design choice, with the different examples each providing unique advantages in their own regard. Further, the choice of the type of joint formed by the joint members, 302 and 304, may even be a preference of the surgeon or audiologist performing the implant procedure.

FIGS. 4-11 illustrate numerous specific examples of the connection apparatus 300 according to the principles of the present invention. As mentioned, however, it is anticipated that numerous other examples of the connection apparatus 300 may be utilized according to the present principles. In addition, those skilled in the art will appreciate how the features described below can be combined to form numerous other examples of the present connection apparatus.

Referring first to FIGS. 4-6 there is shown one example of the connection apparatus 300, namely connection apparatus 400. The connection apparatus 400 includes a first joint member 402 and a second joint member 404 that form a detachable ball joint connection. In this regard, the joint member 404 includes a stud 410 appropriately sized for seating in the interface 306 formed in the incus 122. The stud 410 includes a ball 412 disposed on its distal end to form a detachable connection with the joint member 402. The ball 412 may be a separate structure that is attachable to the stud 410 through an adhesive, weld, solder connection, electrodeposition, or other appropriate biocompatible means. Alternatively, the ball 412 may be integrally formed on the distal end of the stud 410 as a single structure. Each of the above noted examples provides its own unique advantages and may be utilized as a matter of design choice. For instance the latter case provides the advantage of reducing failure of the connection between the ball 412 and the stud 410 following implantation in the patient. The separate structure, however, provides the advantage of allowing the ball 412 as well as the transducer 108 to be removed from the patient in the event it is ever desirable to permanently remove the transducer 108.

The stud 410 is designed for insertion into the interface 306, such that a fibrous union or bone growth between the stud 410 and interface 306 forms a connection therebetween. To facilitate such connection, the stud 410 may be constructed from a ceramic or coated with a ceramic or other suitable material. Further, as mentioned above, an adhesive or other connection means, such as a surface discontinuity, may also be utilized during the implantation to facilitate connection of the stud 410 in the interface 306. Alternatively, the stud 410 may be formed from a material such as a shape memory metal that is configured to expand laterally within the interface 306, in response to a stimulus, to couple the stud 410 to the incus 122. In one preferred example, the stimulus may- be the body's temperature such that the coupling is activated upon placement of the stud 410 in the interface 306. It will be appreciated that such loading may be defined in direct relation to the shape memory attributes of the material comprising the stud 410.

The ball 412 of the joint member 404 is designed to detachably couple with the joint member 402. In this regard, numerous configurations of the joint member 402 may be utilized to achieve the connection with the ball 412 as a matter of design choice. For instance, alternative examples of the joint member 402 are shown are shown in FIGS. 4, 5, and 6B. According to one example of the connection apparatus 400, the joint member 402 includes a receiver 406 disposed on the end of a stem 408. The stem 408 is connected to a distal end 420 of the transducer 108, which as noted above, may be the vibratory member 112. Advantageously, this permits the retrofitting of conventional transducers with the connection apparatus 400 with minimal modification. The connection between the stem 408 and end 420 may be made by any appropriate means that permits the transmission of vibrations to the joint member 402 and ultimately the joint member 404. Some examples of the connection include without limitation, adhesives, a weld, electrodeposition, or other appropriate biocompatible connection.

According to this characterization, the receiver 406 forms a pocket 414 to receive the ball 412, and form the ball Joint connection, illustrated in FIG. 6a. In this regard, the receiver 406 may be constructed in the form of a spring type receiver where the ends, 416 and 418, expand outward as the ball 412 is inserted into the pocket 414, and snap inward around the ball 412 following insertion, to form the connection. The ball 412 is then retained in the pocket 414 via the inward pressure applied by the receiver ends, 416 and 418, but is also permitted to rotate relative to the receiver 406. Advantageously, this permits movement of the incus 122 in at least a first dimension, e.g., rotationally along arc (A) relative to the transducer 108. Such movement of the incus 122 may be caused by a variety of circumstances, most notably including swallowing, changes in barometric pressure, e.g., caused by changes in altitude of the patient, tissue growth, and/or swelling after the implantation surgery. The rotational movement along arc (A), in turn, reduces loading between the incus 122 and the transducer 108, as movement of the incus 122 is permitted relative to the fixed position of the transducer 108.

The stem 408 may be any structure of sufficient rigidity to transmit vibrations to the receiver 406 and ultimately the interconnected joint member 404. For instance, the stem 408 may be a pin, a tube, a wire, etc. preferably formed from a biocompatible material including without limitation, titanium, a titanium alloy, platinum, a platinum alloy, or gold-plated stainless steel. In one example of the present connection apparatus 400, the stem 408 may be constructed such that it is flexible, as illustrated by the dashed line on FIG. 4, in response to compressive forces, while at the same time being resistive to high frequency axial movements to permit efficient axial vibration transfer between the connected joint members 402 and 404. According to this characterization, in response to gradual movements of the incus 122 in a second dimension, e.g., in the direction of the transducer 108, the stem 408 is designed to flex to reduce loading between the incus 122 and transducer 108. Similarly, in response to gradual movements of the incus 122 away from the transducer 108, the ends, 416 and 418, of the receiver 406 are designed to expand apart allowing the ball 412 to also move away from the transducer 108 to reduce loading conditions. It will be appreciated that such movements of the incus 122 relative to the transducer 108 will inherently generate some loading. However, such loading may be reduced by the above design where the stem 408 and/or ends 416 and 418 are configured to flex under a low frequency load, e.g., substantially constant load. It will be appreciated that this load may be predetermined and the stem 408 and ends 416 and 418 designed, to permit low frequency compensating movement of the incus 122 but resist higher frequency vibrations for the transmission of sound to the incus 122.

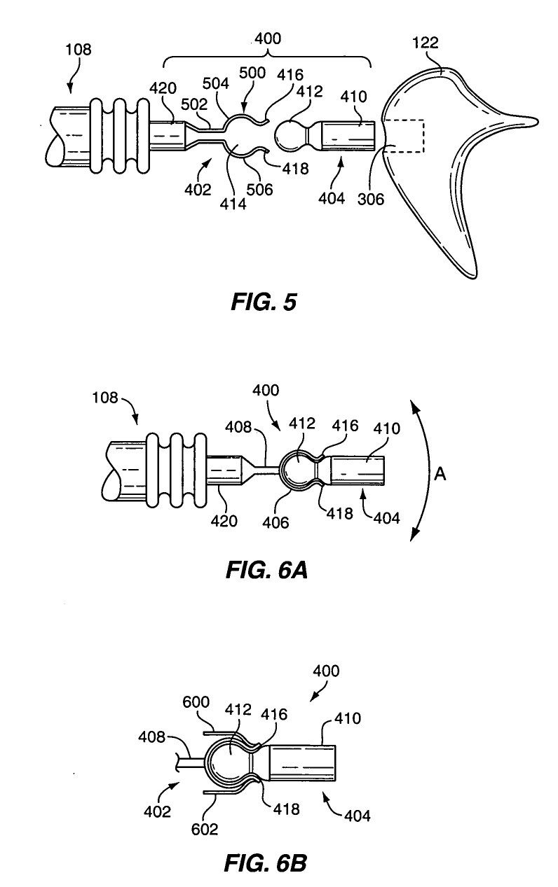

Referring to FIG. 5, another example of the receiver, namely the receiver 500 is shown. In this embodiment, the stem 502 and receiver 500 are constructed from two separate structures, 504 and 506. As with the receiver 406, the receiver 500 is designed such that the structures, 504 and 506, are flexible to permit movement of the ossicles 120 relative to the transducer 108 to reduce loading pressures, while also being resistive to sudden axial movements to permit efficient acoustic stimulation of the joint member 404. In this characterization, if the incus 122 moves in the second dimension, e.g., in the direction of the transducer 108, the receiver 500 and stem structures, 504 and 506, are designed to separate or expand apart allowing the ball 412 to also move toward the transducer 108 and reduce loading pressures. Similarly, if the incus 122 moves away from the transducer 108, the ends, 416 and 418, of the receiver 500 expand apart allowing the ball 412 to also move away from the transducer 108 to reduce loading pressures. As with the above embodiment, the ball 412 and receiver 500 also permit angular movements of the incus 122, via rotation of the ball 412 within the receiver 500, along arc (A). Similarly as with the above embodiment, the structures, 504 and 506, are connected to the distal end 420 of the transducer 108 via any appropriate means, with some examples including without limitation, adhesives, welding, electrodeposition, or other appropriate biocompatible connection.

In another example of the connection apparatus 400, one of the joint members, 402 and 404, may also include structure to facilitate detachment. For example, as shown in FIG. 6A, the joint member 404 includes a pair of opposing tangs 600 and 602 that allow for the application of inward pressure relative to the stem 408 to open the receiver 406 and permit removal of the ball member 412. Advantageously, tangs 600 and 602 permit simple disconnection of the joint members 402 and 404 in a manner that reduces forces on the joint member 404 and incus 122. This in turn reduces the probability of damaging the connection, e.g., fibrous union etc., during disconnection and/or removal of the transducer 108 from the patient.

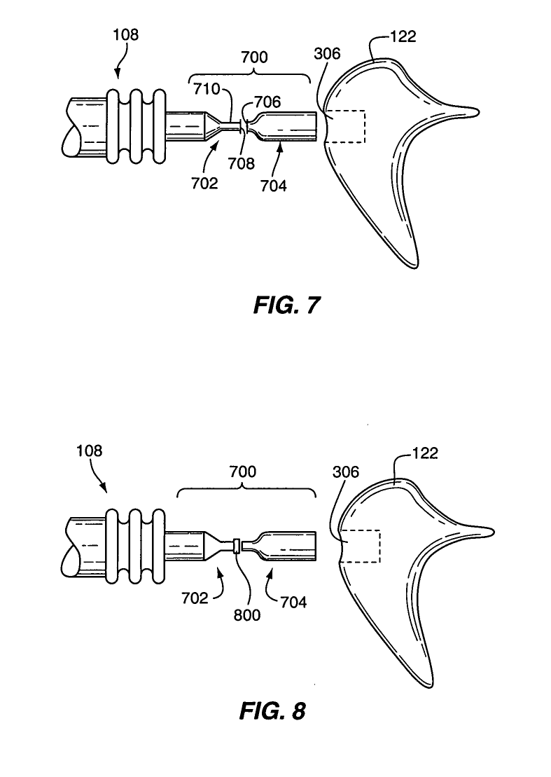

Referring to FIG. 7 there is shown another example of the connection apparatus 400, namely connection apparatus 700. The connection apparatus 700 is similar to the connection apparatus 400 in that it includes a first joint member 702 and a second joint member 704. In contrast, however, the joint members, 702 and 704, form an abutting or adjacent relationship relative to each other for the transmission of mechanical energy therebetween. In this regard, the joint members, 702 and 704, include mating planar surfaces, 706 and 708, that are adjacently disposed during implantation of the transducer 108, such that axial vibrations are transferred therebetween. As with the stud 410, the joint member 704 is designed for insertion into the interface 306, such that bone growth or a fibrous union between the joint member 704 and interface 306 is formed through tissue healing. Alternatively, however, the joint member 704 may be constructed from a material designed to expand laterally within the interface 306 as described above.

The joint member 702, on the other hand, includes a stem 710, the length of which may be varied as a matter of design choice to facilitate the adjacent positioning the planar surfaces, 706 and 708. The stem 710 is connected to a distal end 420 of the transducer 108, which as noted above, may be the vibratory member 112, thereby providing the advantage of permitting retrofitting of conventional transducers with minimal modification.

According to this characterization, the stem 710 may be a pin, a tube, a wire, etc. preferably formed from a biocompatible material including without limitation, titanium, a titanium alloy, platinum, a platinum alloy, or gold-plated stainless steel. In addition, as with the above -embodiment, the stem 710 may be constructed from a material or formed in a manner that permits flexing, as exemplified in FIG. 4b, while at the same time being resistive to- high frequency axial movements to permit efficient acoustic stimulation of the incus 122. Thus, as with the above embodiment, in response to movement of the incus 122 in the second dimension, e.g., toward the transducer 108, the stem 710 may be reduce loading pressures on the incus 122.

In another embodiment, illustrated in FIG. 8, the planer surfaces, 706 and 708, may be coupled using a detachable coupler 800. In one example of this characterization, the coupler 800 may be constructed from a shape memory alloy, including without limitation, NiTinol (trade name for the standard alloy Nickel-Titanium). Such alloys are known for their ability to take on a predetermined shape in response to a stimulus, such as a temperature change, and return to their original shape upon removal of the stimulus. Specifically, shape memory alloys, such as NiTinol, undergo a phase transformation when cooled from their high temperature form, Austenite, to their low temperature form, Martensite. When such alloys are in the Martensite form, they are easily deformed to a new shape. When the alloy is heated, however, they recover their previous shape, hence the name shape memory alloys. Advantageously, for alloys such as NiTinol, the temperature at which the alloy returns to its original shape may be adjusted, typically between in the range of 100 degrees Celsius to negative 100 degrees Celsius.

In yet another embodiment, the ends of the joint members 702 and 704 may be magnetized or formed from materials having a magnetic attraction to facilitate the juxtaposed positioning of the planer surfaces, 706 and 708. Similarly, other means such as an adhesive may also be utilized to facilitate the positioning of the planer surfaces, 706 and 708 as a matter of design choice.

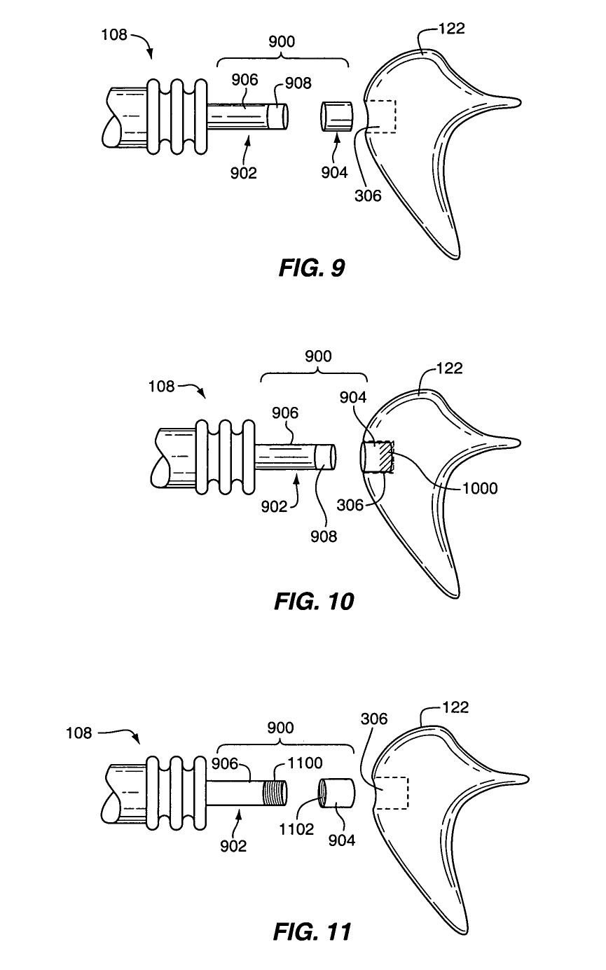

Referring to FIG. 9 another example of the connection apparatus 300 is shown, namely connection apparatus 900. In this example, the connection apparatus 900 includes a first joint member 902 and a second joint member 904 that form a connection between the transducer 1.08 and the incus 122. In this example, the joint member 904 is in the form of a conduit or sleeve designed to receive a tip portion 908 of the joint member 902 to make the connection between the joint members 902 and 904. According to this characterization, the joint member 902 is dimensioned such that it may be recessed into the interface 306, such that it forms a sleeve within the interface 306 that provides a uniform interface for the receipt of the tip portion 908 of the joint member 902. As with the above examples, the joint member 904 may be constructed from a ceramic material to facilitate coupling with the interface 306. Alternatively, however, the joint member 904 may be constructed from a shape memory alloy that is conditioned for actuation at bodily temperatures so that the joint member 904 expands outward after surgical placement in the interface 306 to apply lateral loading and secure the same in the interface 306. Such loading may be defined in direct relation to the shape memory attributes of the material comprising the joint member 902.

The joint member 902, on the other hand, includes an elongated stud member 906 extending axially from the distal end of the transducer 108. As with the stem 710, the length of the stud 906 may be varied as a matter of design choice to facilitate positioning of the transducer 108 and connection with the joint member 904. It will be appreciated that the joint member 902 may be the transducer vibratory member 112 without modification, to realize the advantages of the present connection apparatus.

The joint member 902 may be received in the sleeve 904 without additional coupling therebetween. Alternatively, however, an adhesive or other attachment means may be utilized to further secure connection between the joint members 902 and 904. In still yet another example, the tip portion 908 of the joint member 902 may be formed from a shape memory metal, as described above, such that it expands outward after surgical placement in the joint member 904 to form a connection with the same.

In another example of the connection apparatus 900, a reshapeable material 1000, may also be disposed within the sleeve portion of the joint member 904 prior to connection of the joint member 902 as illustrated in FIG. 10. According to this characterization, the reshapeable material 1000 may serve the dual purpose of retaining the joint member 904 within the sleeve portion of the joint member 904, while permitting gradual movement of the incus 122 relative to the transducer 108 to reduce loading pressures. In other words, the reshapeable material 1000 permits the incus 122 to gradually move or positionally adjust relative to the transducer 108 while reducing loading pressures caused by such movements. Although it will be appreciated that numerous materials (currently in existence and that will be available in the future) exhibiting the above-described properties may be utilized, some examples of the reshapeable material described herein include without limitation, wax based materials, elastomer based materials, and/or silicon based materials.

Referring to FIG. 11, in another example of the connection apparatus 900, the joint members, 902 and 904, may include threads, 1100 and 1102 respectively, for making a threaded connection therebetween. In this regard, the threads 1100 may be connected to the threads 1102 by rotation of the entire transducer 108. Alternatively, the transducer 108 may be configured such that the joint member 902 is rotatable independent of the transducer 108 to make the threaded connection. In either case, the threaded connection provides the advantage of securing in a detachable manner the joint members 902 and 904. Yet, another advantage of this characterization is that the joint members, 902 and 904, may be threaded together prior to implantation of the transducer 108. Thereafter, the joint members, 902 and 904, are easily disconnectable, even after a fibrous union is formed between the joint member 904 and the interface 306 during the healing process.

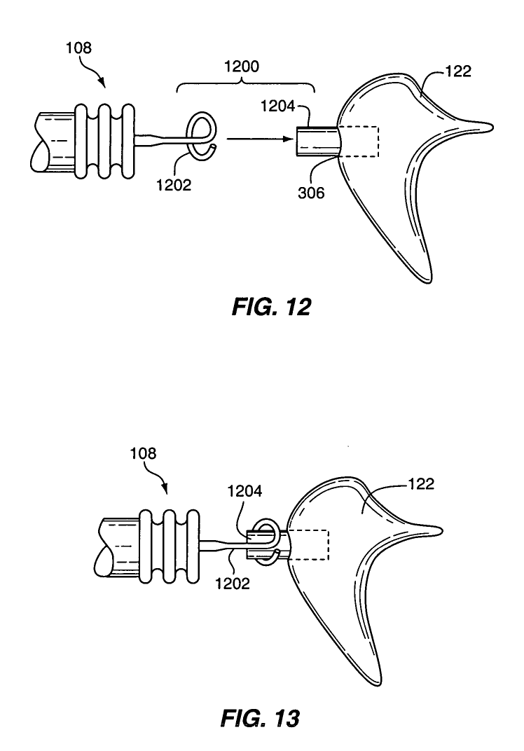

Referring to FIGS. 12 and 13, another example of the connection apparatus 300 is shown, namely connection apparatus 1200. In this example, the connection apparatus 1200 includes a first joint member 1202 and a second joint member 1204 that form a detachable connection between the transducer 108 and incus 122. According to this characterization, the joint member 1204 is a stud connectable to the incus 122 according to any of the above-described methods. The joint member 1202, on the other hand, is in the form of a clamp designed for insertion over the stud 1204 to make the connection. In one example of the joint member 1202, the clamp may be a spring that is separated prior to being inserted over the stud 1204, such that it clamps down on the stud 1204, as shown in FIG. 13, when it is released. In another example of the joint member 1202, the clamp may be crimped around the stud 1204 to make the connection of FIG. 13. In yet another example of the joint member 1202, the clamp may be a shape memory metal, as discussed above, that automatically clamps down on the stud 1204 following insertion over the stud 1204.

Those skilled in the art will appreciate variations of the above-described embodiments that fall within the scope of the invention. As a result, the invention is not limited to the specific examples and illustrations discussed above, but only by the following claims and their equivalents.

1. A method for coupling an implantable hearing aid transducer to a middle ear component of a patient, the method comprising:
providing a first joint member on the transducer;
coupling a second joint member to the middle ear component of the patient; and, interconnecting a portion of the first joint member to a portion of the second joint member to form a detachable physical connection between the first and second joint members during implantation of the transducer to couple the transducer to the middle ear component of the patient.

2. The method of claim 1, comprising:
providing a stimulus representative of sound to the middle ear component over the connected first and second joint members.

3. The method of claim 1, wherein the interconnecting step comprises:
inserting a tip portion of one of the first and second joint members into a receiver portion of the other one of the first and second joint members.

4. (canceled)

5. The method of claim 1, wherein the coupling step comprises:
forming an interface on the middle ear component; and
connecting the second joint member to the interface.

6. The method of claim 5, wherein the connecting step comprises:
placing the second joint member in the interface; and
in response to a stimulus, expanding the second joint member outward relative to the interface to apply lateral loading between the second joint member and the interface.

7. The method of claim 1, the method comprising:
exposing the connected first and second joint members to a movement of the middle ear component relative to the transducer; and
automatically executing a compensating movement of the first and second joint members to reduce loading pressure on the middle ear component.

8. The method of claim 7, wherein the step of executing the compensating movement comprises:
rotating a ball of one of the first and second joint members in a receiver of the other one of the first and second joint members.

9. The method of claim 8, wherein the interconnecting step comprises:
inserting the ball of the one of the first and second joint members in the receiver of the other one of the first and second joint members.

10. The method of claim 7, wherein the step of executing the compensating movement comprises:
flexing a stem of one of the first and second joint members.

11. The method of claim 1, wherein the interconnecting step comprises:
inserting a tip portion of the first joint member in a sleeve portion of the second joint member; and
in response to a stimulus, expanding the tip portion outward to apply lateral loading between the tip portion and the sleeve portion.

12. The method of claim 1, wherein the interconnecting step comprises:
threading the first joint member to the second joint member.

13. The method of claim 1, the method comprising:
disconnecting the first and second joint members; and
removing the transducer and the first joint member from the patient.

14. The method of claim 13, wherein the step of removing comprises:
permanently removing the transducer and first joint member from the patient; and
leaving the second joint member permanently connected to the ossicles of the patient.

15. The method of claim 13, the method comprising:
subsequent to removing the transducer, repairing the transducer;
subsequent to the repairing step, re-implanting the transducer; and
reconnecting the first and second joint members.

16. The method of claim 13, the method comprising:
subsequent to removing the transducer, replacing the transducer with a new transducer;
providing the first joint member on the new transducer;
implanting the new transducer; and
interconnecting the portion of the first joint member to the portion of the second joint member during implantation of the new transducer.

17. A connection apparatus for coupling an implantable hearing aid transducer to a middle ear component of a patient comprising:
a first joint member interconnected to a vibratory member of the transducer;
a second joint member connectable to the middle ear component of the patient; and
means for interconnecting a portion of the first joint member to a portion of the second joint member during implantation of the transducer to provide a detachable physical connection between the interconnected joint members for the transmission of mechanical vibration from the vibratory member to the middle ear component, wherein the means for detachable interconnecting allows for removal of the first joint member independent of removing the second joint member from the middle ear component.

18. (canceled)

19. The connection apparatus of claim 17, wherein the means for interconnecting comprises:
a ball on one of the first and second joint members; and
a receiver on the other one of the first and second joint members sized and shaped to receive the ball.

20. The connection apparatus of claim 19, wherein the receiver further comprises:
a pair of opposing tangs for application of pressure to open the receiver and uncouple the ball from the receiver.

21. The connection apparatus of claim 17, wherein the means for interconnecting comprises:
a first contact surface on a distal end of the first joint member; and
a second contact surface on a distal end of the second joint member, wherein the first and second contact surfaces are adjacently positionable during implantation of the transducer to provide the detachable physical connection.

22. The connection apparatus of claim 21, comprising:
a connector for forming the detachable physical connection between the first and second joint members in the adjacent positional relationship.

23. The connection apparatus of claim 17, wherein the first and second contact surfaces are magnetized.

24. The connection apparatus of claim 17, wherein the second joint member comprises a sleeve and the first joint member comprises a stud member including a tip sized and shaped for insertion into the sleeve.

25. The connection apparatus of claim 17, wherein the means for interconnecting comprises:
mating threads on the first and second joint members.

26. The connection apparatus of claim 17, wherein the first joint member comprises a clamp and the second joint member comprises a stud.

27. The connection apparatus of claim 17, wherein the interconnected first and second joint members are movable relative to each other to reduce load pressures therebetween.
